(19) United States
(12) Patent Application Publication
(10) Pub. No.: US 2012/0061540 A1
(43) Pub. Date: Mar. 15, 2012

(54) Quick-Release Hunting Hook

(76) Inventor: Greg Platt, Windber, PA (US)

(21) Appl. No.: 13/231,471

(22) Filed: Sep. 13, 2011

Related U.S. Application Data
(60) Provisional application No. 61/382,241, filed on Sep. 13, 2010.

(51) Int. Cl. F16B 45/00; F16M 13/02; B23P 11/00

(52) U.S. Cl. 248/225.21; 29/525.08; 248/304

(57) ABSTRACT

A hunting hook may include a first bend having a front end and a back end located at a top portion of the hunting hook; an elongated member extending downwardly from the back end of the first bend away from the top portion of the hunting hook; a hook shank extending downwardly from the front end of the first bend away from the top portion of the hunting hook, the hook shank being angled toward the elongated member; and a second bend having a front end that extends radially away in a clockwise direction from the hook shank, the second bend front end being angled toward the first bend, wherein the elongated member extends downwardly beyond the second bend away from the top portion of the hunting hook. A hunting hook system for hanging hunting equipment and a method of hanging hunting equipment are also disclosed.

### CROSS REFERENCE TO RELATED APPLICATIONS

The present application claims priority to U.S. Provisional Patent Application No. 61/382,241, filed Sep. 13, 2010, entitled “Quick-Release Hunting Hook”, which is hereby incorporated by reference in its entirety.

### BACKGROUND OF THE INVENTION

1. Field of the Invention

This invention relates to hunting hooks and, more particularly, to hunting hooks which are attachable and releasable to belts secured around trees.

2. Description of Related Art

While hunting, particularly when waiting in one spot, hunters oftentimes require places to store their equipment, such as bows, rifles, bags, or other types of equipment. A convenient way of storing equipment is by hanging equipment on a tree. One method of hanging equipment on a tree is by a hook. However, currently available hooks are often preattached to bulky equipment or are permanently attached to belts that are to be secured around a tree, causing the hunter to waste time, make excessive noise, or buy several relatively expensive accessory belts. Alternatively, some hooks need to be screwed into a tree, wasting time and requiring excessive noise. These hooks can also be unnecessarily expensive. There exists a need for a hunting hook that is lightweight, inexpensive, easily transportable, and releasably attachable to equipment a hunter is already carrying or has deployed in the field.

### SUMMARY OF THE INVENTION

A hunting hook may include a first bend having a front end and a back end located at a top portion of the hunting hook; an elongated member extending downwardly from the back end of the first bend away from the top portion of the hunting hook; a hook shank extending downwardly from the front end of the first bend away from the top portion of the hunting hook, the hook shank being angled toward the elongated member; and a second bend having a front end that extends radially away in a clockwise direction from the hook shank, with the second bend front end being angled toward the first bend. The elongated member extends downwardly beyond the second bend away from the top portion of the hunting hook and may, for example, extend downwardly at least two times the distance of the hook shank. The hunting hook, including the first bend, the elongated member, the hook shank, and the second bend may be an integrally formed single continuous member, which may, for example, be circular in cross-sections. The elongated member may include an offset extension member, which may be offset in a direction of the front end of the first bend. The offset extension member may extend downwardly angled back in a direction of the back end of the first bend and may define a ledge on an inside portion of the elongated member.

A method of hanging equipment on a vertical support may include the steps of securing a first belt around a first vertical support; sliding an elongated member extending downwardly from a back end of a first bend located at a top portion of a hook between the vertical support and the belt after securing the belt around the vertical support; and hanging equipment on the hook. The first vertical support could comprise a tree, wherein the step of securing a first belt comprises securing the belt around the circumference of the tree. The method may also include the steps of removing the hook without removing the belt and replacing the hook on another location on the belt by sliding the hook's elongated member between the vertical support and the belt. The hook of this method may include a hook shank extending downwardly from the top portion of the hook at a front end of the hook, the shank being angled toward the elongated member. The method may also include securing a second belt to a second vertical support; removing the hook without removing the first belt from the first vertical support; and replacing the hook on the second belt on the second vertical supports. Both the first and second vertical support could comprise trees, and the steps of securing the first belt and the second belt could include securing the first and second belts around the first and second trees, respectively.

A hunting hook system for hanging hunting equipment may include a hook and a belt for securing around a vertical support. The hook may have a first bend having a front end and a back end located at a top portion of the hunting hook; an elongated member extending downwardly from the back end of the first bend away from the top portion of the hunting hook; a hook shank extending downwardly from the front end of the first bend away from the top portion of the hunting hook, the hook shank being angled toward the elongated member; and a second bend having a front end that extends radially away in a clockwise direction from the hook shank, with the second bend front end being angled toward the first bend, wherein the elongated member extends downwardly beyond the second bend away from the top portion of the hunting hook. When the belt is secured around a vertical support, the hook may be removably secured to the belt with the hook's elongated member positioned behind the belt and the shank and the second bend being positioned in front of the belt. The system could also include a hook, wherein the elongated member, the hook shank, and the second bend are integrally formed to form a single continuous member. The elongated member of the hook could include an offset extension member, which could, for example, be offset in a direction of the front end of the first bend. The offset extension member could extend downwardly and be angled back in a direction of the back end of the first bend and could, for example, define a ledge on an inside portion of the elongated member.

### BRIEF DESCRIPTION OF THE DRAWINGS

FIG. 1 is an embodiment of a hunting hook;

FIG. 2 is another embodiment of a hunting hook;

FIG. 3 shows the hunting hook of FIG. 1 attached to a tree;

FIG. 4 shows the hunting hook of FIG. 1 in use;

FIG. 5 shows the hunting hook of FIG. 2 attached to a tree;

FIG. 6 shows the hunting hook of FIG. 2 in use; and

FIG. 7 is a process flow diagram of a method of hanging equipment .

### DESCRIPTION OF THE PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments and that the specific embodiments illustrated in the accompanying drawing figures and described herein are simply exemplary and should not be considered as limiting.

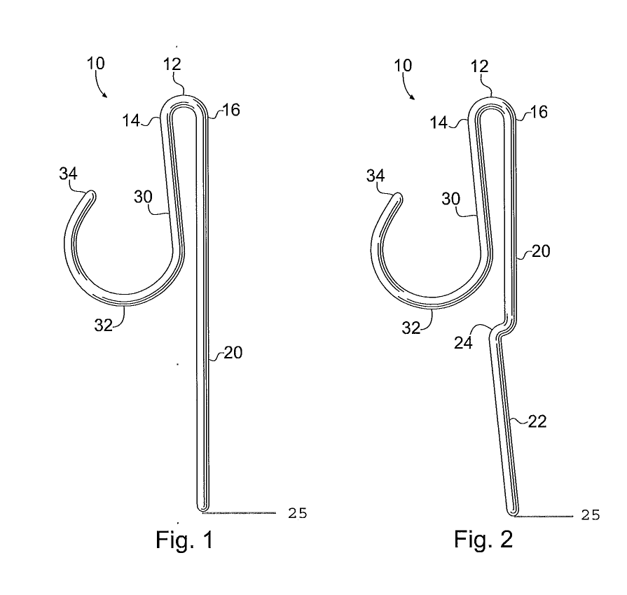

Referring to FIGS. 1 and 2, examples of a quick-release hunting hook 10 are shown. In one embodiment of the quick-release hunting hook 10, specifically with reference to FIG. 1, the quick-release hunting hook 10 includes a first bend 12, an elongated member 20 having bottom tip 25, a hook shank 30, and a second bend 32. The first bend 12 includes a front end 14 and a back end 16, located at the top portion of the hunting hook 10. The elongated member 20 extends downwardly from the back end 16 of the first bend 12 away from the top portion of the hunting hook 10. The hook shank 30 also extends downwardly from the front end 14 of the first bend 12; however, the hook shank 30 is angled backward toward the elongated member 20. The second bend 32 has a front end 34 that extends radially away in a clockwise direction from the hook shank 30 with the second bend 32 front end 34 being angled towards the first bend 12. The elongated member 20, as shown in FIG. 1, extends downwardly beyond the second bend 32 away from the top portion of hunting hook 10.

Referring now to FIG. 2, another embodiment of the hunting hook 10 also includes elongated member 20 extending beyond the second bend 32 in a downward direction; however, elongated member 20 also includes an offset extension member 22. As shown, the offset extension member 22 may be offset in the direction of the front end 14 of the first bend 12. In this manner, the offset extension member 22 defines a ledge 24 on an inside portion of the elongated member 20. The offset extension member 22 also may extend downwardly, such that it is angled back in a direction of the back end 16 of the first bend 12.

Referring to both the embodiments shown in FIGS. 1 and 2, the total length of the elongated member 20, and in the case of FIG. 2 including offset extension member 22, may be at least two times the length of the hook shank 30 from the top portion of hunting hook 10.

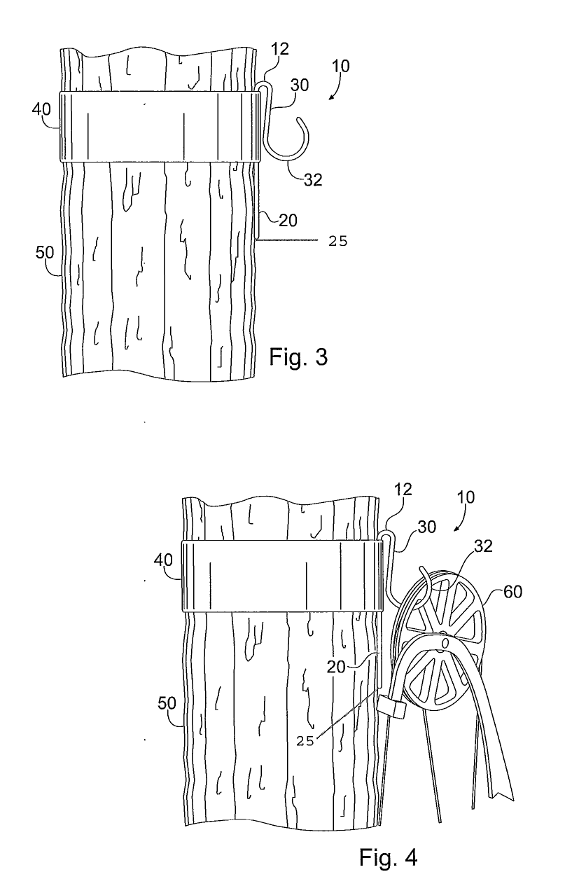

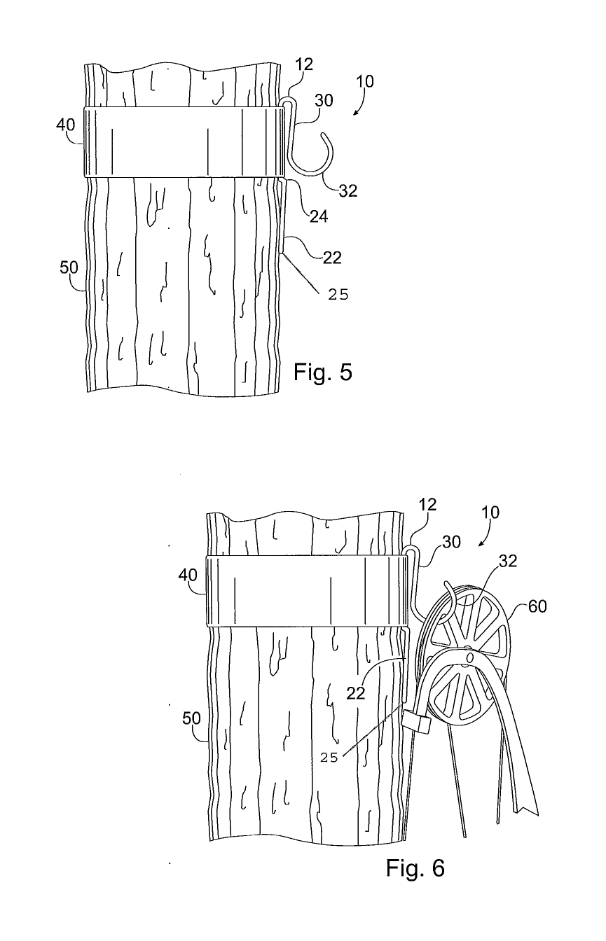

Referring to FIGS. 3 and 5, the embodiments of the hunting hook 10 shown in both FIGS. 1 and 2, respectively, may be positioned behind a belt 40 secured to a vertical support, such as tree 50. Generally, the belt 40 may be a belt that would have been previously attached to the tree 50, i.e., for attaching a ladder tree stand or a hang-on tree stand to a tree. When the hunting hook 10 needs to be used, the user simply slides the elongated member 20 behind the belt 40, such that the elongated member 20 is positioned between the belt 40 and the vertical support, like tree 50. The belt 40 is then secured between the shank 30 and the elongated member 20 of the hunting hook 10.

Referring specifically to FIG. 5, the ledge 24, formed by offset extension member 22 on elongated member 20, provides additional support for securing the hunting hook 10 to the belt 40.

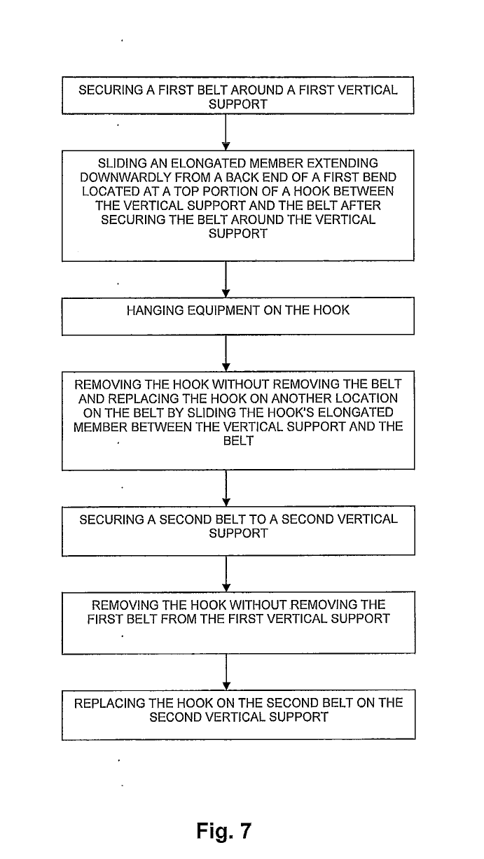

Referring to FIGS. 4 and 6, hunting hook 10 may then receive, over second bend 32, hunting equipment 60, such as a bow, a rifle, a bag, or other type of hunting equipment. Other devices that may be hung on the hook 10 include coffee cups or thermoses, ammunition or ammunition clips, archery quivers, or cameras or video recorders to record hunts or portions of hunts. A method of using the hunting hook 10 to hang equipment is summarized in the process flow diagram of FIG. 7. If the user wishes to move the equipment 60 to another position on the tree 50, the user simply can remove the hunting equipment 60 and easily slide elongated member 20 out from behind the belt 40 and replace the hunting hook 10 by sliding the elongated member 20 behind belt 40 at another position of tree 50. The user can then reattach hunting equipment 60 on hunting hook 10. Alternatively, the user can secure a second belt to a second tree and replace hook 10 on the second belt in the same manner in which the hook 10 was secured to the first belt 40. The second belt on the second tree may be a preexisting belt that was previously being used in conjunction with other hunting equipment. The elongated member 20 and, in the case of FIG. 6, offset extension member 22 is positioned against the tree 50 when hunting hook 10 is engaged with the belt 40. This configuration provides additional support when hunting equipment 60 is hung on hunting hook 10, as the elongated member 20 will provide stabilization by abutting against the tree 50. When removing hunting equipment 60 from the hook 10, the equipment 60, which is lifted by a user, may cause the hook to inadvertently be lifted from the belt 40. The ledge 24 provides additional retention of the hook 10 onto the belt 40 by catching the bottom portion of the belt 40 on the ledge 24 of offset extension member 22. Alternative embodiments, including the same general configuration, may include cup or thermos holders, ammunition or ammunition clip holders, archery quivers, or cameras or video recorder holders which are slidable between belt 40 and tree 50 in the same manner as hook 10.

The above-described hunting hook 10 provides significant advantages over other devices. Unlike currently marketed hooks which come permanently attached to the belts or must be screwed into the tree, or which must be removed from the tree after the belt has been removed from the tree, the above-described hunting hook 10 can be carried by the user to allow more room for other items. The hunting hook 10 can be used with belts that are already in use by the user, such as a belt supporting a tree stand to a tree. The hunting hook 10 includes features that make it easy to use. The lowest tip on the device 25 extends well below the hook 10. In addition to providing stability, the tip 25 can be used to slide the hook 10 between the tree 50 and the belt 40, which is attached to the tree 50. Once the tip 25 is slid between the top of the belt 40 and the tree 50, the remainder of elongated member 20, and hence the hook 10, is easily slid downward. The design between the bend 32 and the elongated member 20 provides generous “lead-in” that easily enables the hook 10 to slide downward until the hunting hook 10 rests onto the belt 40 at the first bend 12. The design of hunting hook 10 is compact and lightweight. The entire hunting hook 10, including the first bend 12, the elongated member 20, and/or offset extension member 22, the shank 30, and the second bend 32 may be an integrally formed single continuous member, such as a piece of material having a circular cross-section. Any lightweight material that enables easy storage and transportation and that is durable and lightweight is contemplated by the present invention.

While specific embodiments of the above-described hunting hook have been described in detail, it will be appreciated by those skilled in the art that various modifications and alternatives to those details could be developed in light of the overall teachings of the present disclosure. The presently preferred embodiments described herein are meant to be illustrative only and not limiting as to the scope of the invention, which is to be given the full breadth of the appended claims and any and all equivalents thereof.

The invention claimed is:

1. A hunting hook comprising:
a first bend having a front end and a back end located at a top portion of the hunting hook;
an elongated member extending downwardly from the back end of the first bend away from the top portion of the hunting hook;
a hook shank extending downwardly from the front end of the first bend away from the top portion of the hunting hook, the hook shank being angled toward the elongated member; and
a second bend having a front end that extends radially away in a clockwise direction from the hook shank, the second bend front end being angled toward the first bend,
wherein the elongated member extends downwardly beyond the second bend away from the top portion of the hunting hook.

2. The hunting hook of claim 1, wherein the first bend, the elongated member, the hook shank, and the second bend are integrally formed to form a single continuous member.

3. The hunting hook of claim 2, wherein the single continuous member is circular in cross-section.

4. The hunting hook of claim 1, wherein the elongated member includes an offset extension member.

5. The hunting hook of claim 4, wherein the offset extension member is offset in a direction of the front end of the first bend.

6. The hunting hook of claim 5, wherein the offset extension member extends downwardly and is angled back in a direction of the back end of the first bend.

7. The hunting hook of claim 4, wherein the offset extension member defines a ledge on an inside portion of the elongated member.

8. The hunting hook of claim 1, wherein the elongated member extends downwardly at least two times the distance the hook shank extends downwardly.

9. A method of hanging equipment on a vertical support comprising the steps of:
securing a first belt around a first vertical support;
sliding an elongated member extending downwardly from a back end of a first bend located at a top portion of a hook between the vertical support and the belt after securing the belt around the vertical support; and
hanging equipment on the hook.

10. The method of claim 9, wherein the first vertical support comprises a tree, and the step of securing a belt comprises securing the belt around the circumference of the tree.

11. The method of claim 9, further comprising the steps of removing the hook without removing the belt and replacing the hook on another location on the belt by sliding the hook's elongated member between the vertical support and the belt.

12. The method of claim 9, further comprising the steps of:
securing a second belt to a second vertical support;
removing the hook without removing the first belt from the first vertical support; and
replacing the hook on the second belt on the second vertical support.

13. The method of claim 12, wherein the first vertical support comprises a first tree, and the step of securing the first belt comprises securing the belt around the circumference of the first tree, and
wherein the second vertical support comprises a second tree, and the step of securing the second belt comprises securing the belt around the circumference of the second tree.

14. The method of claim 9, wherein the hook comprises a hook shank extending downwardly from the top portion of the hook at a front end of the hook, the shank being angled toward the elongated member.

15. A hunting hook system for hanging hunting equipment comprising:
a hook having:
a first bend having a front end and a back end located at a top portion of the hunting hook;
an elongated member extending downwardly from the back end of the first bend away from the top portion of the hunting hook;
a hook shank extending downwardly from the front end of the first bend away from the top portion of the hunting hook, the hook shank being angled toward the elongated member; and
a second bend having a front end that extends radially away in a clockwise direction from the hook shank, the second bend front end being angled toward the first bend,
wherein the elongated member extends downwardly beyond the second bend away from the top portion of the hunting hook; and
a belt for securing around a vertical support, wherein, when the belt is secured around the vertical support, the hook is removably secured to the belt with the hook's elongated member positioned behind the belt and the shank and the second bend being positioned in front of the belt.

16. The system of claim 15, wherein the elongated member, the hook shank, and the second bend are integrally formed to form a single continuous member.

17. The system of claim 15, wherein the elongated member includes an offset extension member.

18. The system of claim 17, wherein the offset extension member is offset in a direction of the front end of the first bend.

19. The system of claim 18, wherein the offset extension member extends downwardly and is angled back in a direction of the back end of the first bend.

20. The system of claim 17, wherein the offset extension member defines a ledge on an inside portion of the elongated member.
